(19) United States
(12) Patent Application Publication
(10) Pub. No.: US 2009/0308153 A1
(43) Pub. Date: Dec. 17, 2009

(54) METHOD AND SYSTEM FOR TESTING A DRYER

(75) Inventor: Che-Hua YANG, Taipei (TW)

Correspondence Address: Muncy, Geissler, Olds & Lowe, PLLC, P.O. BOX 1364, FAIRFAX, VA, 22038-1364, US

(73) Assignee: HOKWANG INDUSTRIES CO., LTD.

(21) Appl. No.: 12/139,855

(22) Filed: Jun. 16, 2008

(51) Int. Cl. G01M 19/00; G01N 19/00; F26B 21/04

(52) U.S. Cl. 73/168; 73/865.9; 392/380

(57) ABSTRACT

The present invention discloses a method and system for testing a dryer, which applies to test a dryer outputting hot air from an outlet to fill a drying space and evaluate the drying efficiency of the dryer. In the method of the present invention, a test pattern is arranged inside the drying space of the dryer, and an initial water content is added to the surface of the test pattern; next, the dryer is turned on to output hot air to the drying space to begin the test; during the test, the test pattern is moved inside the drying space to have a displacement travel; then, a drying loss and a drying test time is obtained and used to calculate the drying efficiency of the dryer. Therefore, the present invention simulates the behavior of a subject in using a dryer to attain an accurate drying efficiency of the dryer.

### FIELD OF THE INVENTION

The present invention relates to a method and system for testing a dryer, particularly to a method and system for testing a dryer providing hot air to dry a region of a human body.

### BACKGROUND OF THE INVENTION

Hand dryers are used to blow-dry water on hands and very popular in lavatories. A common hand dryer available in the market uses a heater to heat air coming from the external and sends out hot air from an outlet to accelerate the vaporization of water on hands of a user. For conventional hand dryers, please refer to U.S. Pat. No. 6,185,838, U.S. Pat. No. 6,651,356, U.S. Pat. No. 6,769,197, U.S. Pat. No. 5,459,944, and U.S. Pat. No. 4,999,929.

The hand dryer is a substitute for absorbent paper removing water on hands after hand washing. Hand dryers can reduce paper consumption and benefit environmental protection. However, hot air of a hand dryer cannot remove water on hands as fast as absorbent paper. A hand dryer needs a warm-up time and a blow-drying time to fully dry the hands. Thus, many manufacturers produce high-power hand dryers to speed up hand drying and announce that they can complete hand drying in a short time. In the conventional methods for testing a hand dryer, a water-containing object is placed below the hot air outlet of the hand dryer. However, the hands neither remain still nor always face the outlet by the same side in actual hand drying. Therefore, the results of the conventional test methods cannot enable the users to select hand dryers fairly.

### SUMMARY OF THE INVENTION

The primary objective of the present invention is to fully simulate the user's behavior in using a hand dryer to obtain impartial and impersonal test results. To achieve the above-mentioned objective, the present invention proposes a method for testing a dryer, which applies to a dryer outputting hot air from an outlet to fill a drying space, and which comprises steps:
a) arranging a test pattern in the drying space, and giving an initial water content to the surface of the test pattern;
b) turning on the dryer to output hot air to the drying space;
c) moving the test pattern to generate a displacement travel inside the drying space; and
d) obtaining the drying loss (with respect to the initial water content) and the drying test time to work out the drying efficiency of the dryer.

In the method of the present invention, the test pattern has a water retention unit to keep water adhering to the surface of the test pattern. The water retention unit may be a water absorption material or a water keeping agent. The test pattern is fabricated to have a shape of a hand so as to imitate the usage condition as much as possible. One end of the test pattern is coupled to a displacement driving device, which enables the test pattern to have a displacement travel. The displacement travel may be a horizontal displacement travel, a vertical displacement travel, a rotational displacement travel, a tilting displacement travel, or a combination of the above-mentioned displacement travels. In addition to simulating a hand, the shape of the test pattern may also vary to imitate different test subjects.

In one embodiment, the method of the present invention further comprises a step of turning off the dryer, which will be undertaken when the drying loss reaches a target loss or when the drying test time reaches a target test time.

In another embodiment, the method of the present invention further comprises a step of removing the test pattern away from the drying space, which will be undertaken when the drying loss reaches a target loss or when the drying test time reaches a target test time.

The present invention also proposes a system for testing a dryer, which adapts to the above-mentioned method, and which applies to a dryer outputting hot air from an outlet to fill a drying space. The system of the present invention comprises: a test pattern, a displacement driving device coupled to the test pattern, and a test unit coupled to the test pattern. The test pattern is arranged in the drying space and has an initial water content on the surface thereof. The displacement driving device enables the test pattern to have a displacement travel inside the drying space. The test unit obtains the drying loss (with respect to the initial water content) and the drying test time. A processing unit may be coupled to the test unit to work out the drying efficiency of the dryer according to the drying loss and the drying test time.

In the system of the present invention, the test pattern has a water retention unit to keep water adhering to the surface of the test pattern. The water retention unit may be a water absorption material or a water keeping agent. The test pattern is fabricated to have a shape of a hand so as to imitate the usage condition as much as possible. The displacement travel may be a horizontal displacement travel, a vertical displacement travel, a rotational displacement travel, a tilting displacement travel, or a combination of the above-mentioned displacement travels. In addition to simulating a hand, the shape of the test pattern may also vary to imitate different test subjects.

The method and system for testing a dryer of the present invention standardizes the test of dryers and can fully simulate the usage of dryers, whereby users can impartially and impersonally evaluate the efficiency of dryers.

### BRIEF DESCRIPTION OF THE DRAWINGS

FIG. 1 is a diagram schematically showing a system for testing a dryer according to a preferred embodiment of the present invention.

FIG. 2 is a flowchart showing a method for testing a dryer according to a preferred embodiment of the present invention.

FIG. 3 is a flowchart showing a method for testing a dryer according to another preferred embodiment of the present invention.

### DETAILED DESCRIPTION OF THE PREFERRED EMBODIMENTS

Below, the technical contents of the present invention will be described in detail in cooperation with the drawings.

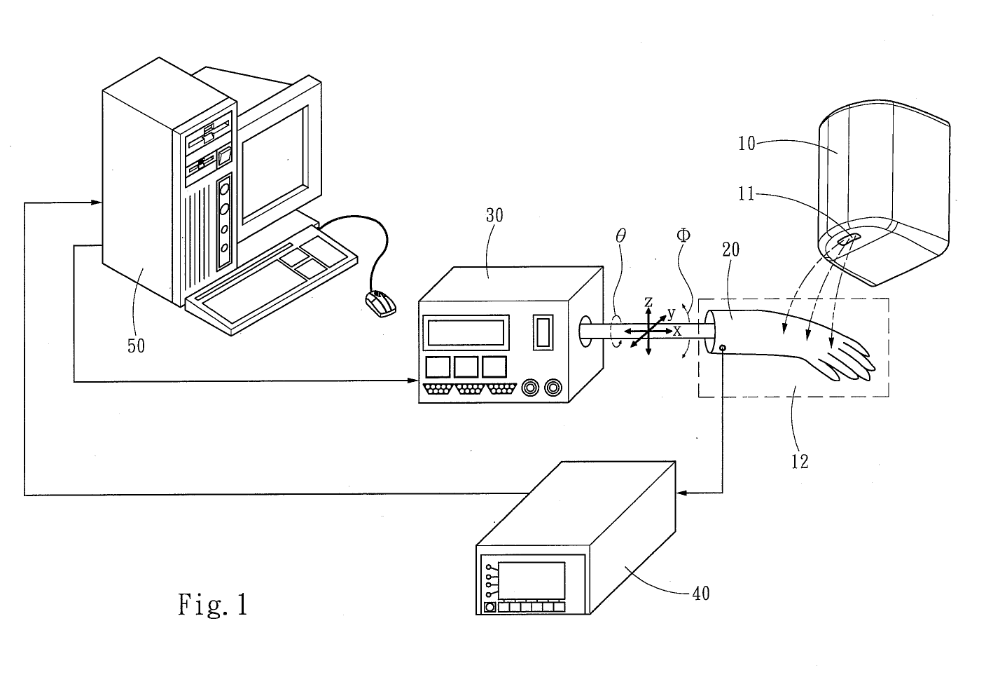

Refer to FIG. 1, a diagram schematically showing a system for testing a dryer according to a preferred embodiment of the present invention. The system of the present invention applies to a dryer 10 outputting hot air from an outlet 11 to fill a drying space 12. The drying space 12 is a space defined by a physical frame or only the region the hot air can reach. The system of the present invention comprises: a test pattern 20, a displacement driving device 30 coupled to the test pattern 20, and a test unit 40 coupled to the test pattern 20. The test pattern 20 is arranged in the drying space 12 and has an initial water content on the surface thereof. The displacement driving device 30 enables the test pattern 20 to have a displacement travel inside the drying space 12. The displacement driving device 30 may be electrically or mechanically driven, such as by a motor or a mechanical device. However, the driving method of the displacement driving device 30 is not limited in the present invention. The test unit 40 obtains the drying loss (with respect to the initial water content) and the drying test time of the test pattern 20. The test unit 40 may be realized by a weight measurement device. Besides, a processing unit 50 may be electrically coupled to the test unit 40 to work out the drying efficiency of the dryer 10 according to the drying loss and the drying test time. The processing unit 50 may be a computer system.

The test pattern 20 has a water retention unit wrapping the surface thereof to prevent water from being flung away by motion or vibration lest errors occur in the test procedures. The water retention unit is a water absorption material or a water keeping agent, such as a piece of cloth, absorbent paper, leather, or water-absorbent gel, which can guarantees that water cannot leave the surface of the test pattern 20 except by vaporization. In this embodiment, the test pattern 20 imitates a hand. However, the shape of the test pattern 20 may also vary to imitate different test subjects. For example, when the system for testing a dryer is used to test a foot dryer, the shape of the test pattern 20 is varied to imitate a foot. For simulating the user's behavior in using the dryer, the displacement driving device 30 drives the test pattern 20 to have a displacement travel inside the drying space 12, and the displacement travel may be a horizontal displacement travel (X, Y), a vertical displacement travel (Z), a rotational displacement travel (θ), a tilting displacement travel (Φ), or a combination of the above-mentioned displacement travels. A displacement edit program is built in the displacement driving device 30, and the displacement driving device 30 alone drives the test pattern 20 to have a displacement travel. Alternatively, the displacement edit program is built in the processing unit 50, and the processing unit 50 sends out a displacement control signal to the displacement driving device 30. Thereby, the tester can use different displacement travels to test dryers.

Via the system for testing a dryer of the present invention, the test pattern 20 can simulate the conditions and user's actions in using a hand dryer. Thereby, the tester can obtain the genuine efficiency of the dryer 10.

The present invention also proposes a method for testing a dryer, which adapts to the above-mentioned system, and which applies to a dryer outputting hot air from an outlet to fill a drying space. The method of the present invention comprises steps:
a) arranging a test pattern in the drying space, and giving an initial water content to the surface of the test pattern;
b) turning on the dryer to output hot air to the drying space;
c) moving the test pattern to generate a displacement travel inside the drying space; and
d) obtaining the drying loss (with respect to the initial water content) and the drying test time to work out the drying efficiency of the dryer.

In the method of the present invention, the test pattern also has a water retention unit mentioned above. The water retention unit is a water absorption material or a water keeping agent. In this embodiment, the test pattern is fabricated to have a shape of a hand. The displacement travel may be a horizontal displacement travel, a vertical displacement travel, a rotational displacement travel, a tilting displacement travel, or a combination of the above-mentioned displacement travels. One end of the test pattern is coupled to a displacement driving device, which enables the test pattern to have a displacement travel. The displacement driving device may be electrically or mechanically driven, such as by a motor or a mechanical device. However, the driving method of the displacement driving device is not limited in the present invention.

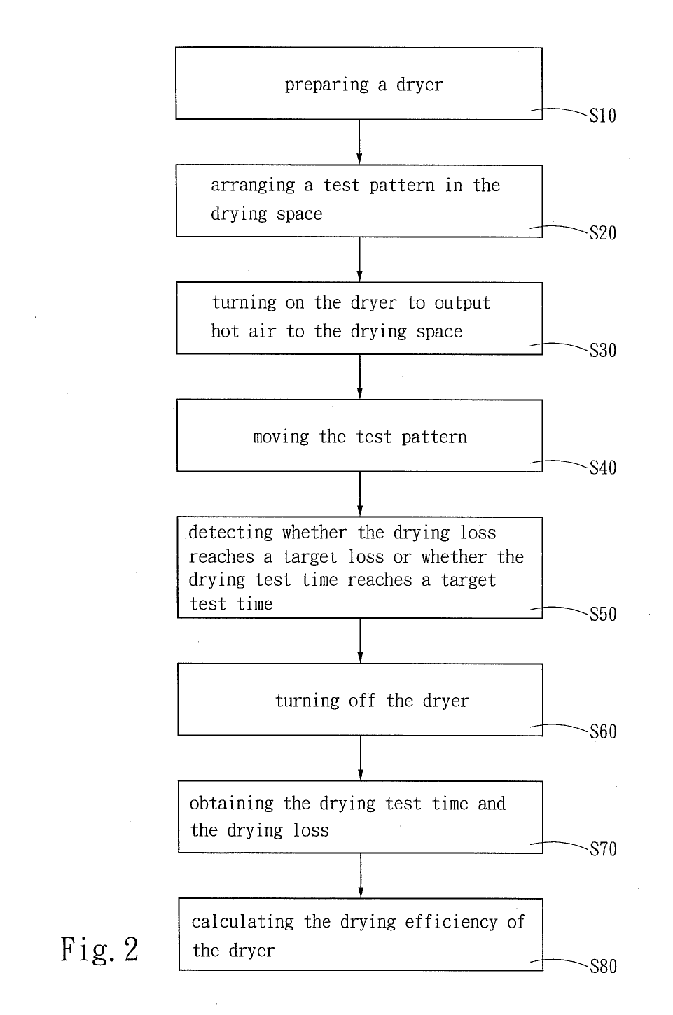

Refer to FIG. 2, a flowchart showing a method for testing a dryer according to a preferred embodiment of the present invention. When a test is to be performed, a dryer is prepared firstly (Step S10). Next, a test pattern is arranged inside the drying space of the dryer (Step S20), and an initial water content is added to the surface of the test pattern. Next, the dryer is turned on to output hot air to the drying space (Step S30) to begin the test. During the test, the test pattern is moved (Step S40) inside the drying space to have a displacement travel and simulate the user's behavior in using the dryer. Next, the system detects whether the drying loss reaches a target loss or whether the drying test time reaches a target test time (Step S50). Once the drying loss reaches a target loss or the drying test time reaches a target test time, the dryer is turned off (Step S60) to stop outputting hot air. Next, the tester obtains the drying test time and the drying loss (with respect to the initial water content) (Step S70) via an electronic measurement or a manual measurement. Then, the drying efficiency of the dryer is worked out according to the drying loss and the drying test time (Step S80).

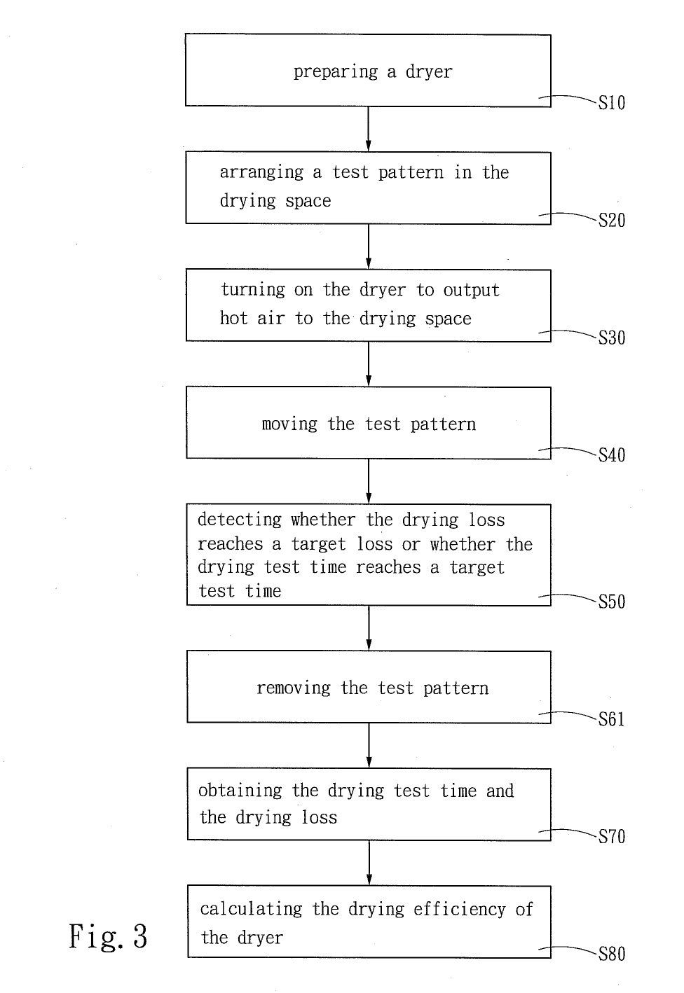

Refer to FIG. 3, a flowchart showing a method for testing a dryer according to another preferred embodiment of the present invention. In this embodiment, the above-mentioned Step S60 of turning off the dryer is replaced by a step of removing the test pattern away from the drying space (Step S61). Similarly, Step S61 is undertaken when the drying loss reaches a target loss or the drying test time reaches a target test time.

In conclusion, the method and system for testing a dryer of the present invention can fully simulate the user's behavior in using a dryer, whereby testers can impartially and impersonally evaluate the efficiency of a hand dryer. Therefore, the present invention has improvements over the conventional technologies and meets the conditions for a patent. Thus, the Inventor files the application for a patent. It will be appreciated if the patent is approved fast.

The embodiments described above are only to exemplify the present invention but not to limit the scope of the present invention. Therefore, any equivalent modification or variation according to the spirit of the present invention is to be also included within the scope of the present invention.

What is claimed is:

1. A method for testing a dryer, which applies to a dryer outputting hot air from an outlet to fill a drying space, and which comprises steps:
arranging a test pattern in said drying space, and giving an initial water content to the surface of said test pattern;
turning on said dryer to output hot air to said drying space;
moving said test pattern to generate a displacement travel inside said drying space; and
obtaining a drying loss (with respect to said initial water content) and a drying test time to work out a drying efficiency of said dryer.

2. The method for testing a dryer according to claim 1, wherein said test pattern has a water retention unit to keep water adhering to the surface of said test pattern.

3. The method for testing a dryer according to claim 2, wherein said water retention unit is a water absorption material or a water keeping agent.

4. The method for testing a dryer according to claim 1, wherein said test pattern imitates a hand.

5. The method for testing a dryer according to claim 1, wherein one end of said test pattern is coupled to a displacement driving device.

6. The method for testing a dryer according to claim 1, wherein said displacement travel is a horizontal displacement travel, a vertical displacement travel, a rotational displacement travel, a tilting displacement travel, or a combination of the said displacement travels.

7. The method for testing a dryer according to claim 1 further comprising a step of turning off said dryer to stop outputting hot air.

8. The method for testing a dryer according to claim 7, wherein said dryer is turned off once said drying loss reaches a target loss.

9. The method for testing a dryer according to claim 7, wherein said dryer is turned off once said drying test time reaches a target test time.

10. The method for testing a dryer according to claim 1 further comprising a step of removing said test pattern away from said drying space.

11. The method for testing a dryer according to claim 10, wherein said test pattern is removed once said drying loss reaches a target loss.

12. The method for testing a dryer according to claim 10, wherein said test pattern is removed once said drying test time reaches a target test time.

13. A system for testing a dryer, which applies to a dryer outputting hot air from an outlet to fill a drying space, and which comprises:
a test pattern, arranged in said drying space and having an initial water content to the surface thereof;
a displacement driving device, coupled to said test pattern and driving said test pattern to have a displacement travel inside said drying space; and
a test unit, coupled to said test pattern and obtaining a drying loss (with respect to said initial water content) and a drying test time of said test pattern.

14. The system for testing a dryer according to claim 13, wherein said test pattern has a water retention unit to keep water adhering to the surface of said test pattern.

15. The system for testing a dryer according to claim 14, wherein said water retention unit is a water absorption material or a water keeping agent.

16. The system for testing a dryer according to claim 13, wherein said test pattern imitates a hand.

17. The system for testing a dryer according to claim 13, wherein said displacement travel is a horizontal displacement travel, a vertical displacement travel, a rotational displacement travel, a tilting displacement travel, or a combination of the said displacement travels.

18. The system for testing a dryer according to claim 13, wherein a processing unit is electrically coupled to said test unit and works out a drying efficiency of said dryer according to said drying loss and said drying test time.
